(19) United States
(12) Patent Application Publication
(10) Pub. No.: US 2023/0177102 A1
(43) Pub. Date: Jun. 8, 2023

(54) GENERATING A DOCUMENT UTILIZING KEY ELEMENTS OF A CLOUD-BASED WORD PROCESSING SYSTEM

(71) Applicant: Frank Vahid, Santa Ana, CA (US)

(72) Inventor: Frank Vahid, Santa Ana, CA (US)

(21) Appl. No.: 17/959,129

(22) Filed: Oct. 3, 2022

Related U.S. Application Data
(60) Provisional application No. 63/253,034, filed on Oct. 6, 2021.

(51) Int. Cl. G06F 16/958; G06F 40/109; G06F 40/166; G06F 40/143

(52) U.S. Cl. CPC G06F 16/958; G06F 40/109; G06F 40/166; G06F 40/143

(57) ABSTRACT

A method includes receiving first data from a cloud-based word processing system. The method further includes extracting, from the first data, one or more key elements. The method further includes dividing the first data into components based on the one or more key elements. The method further includes rendering a first document based on the components of the first data and the one or more key elements.

### RELATED APPLICATIONS

This application claims the benefit of U.S. Provisional Application No. 63/253,034, filed Oct. 6, 2021, the entire contents of which are incorporated by reference.

### TECHNICAL FIELD

Aspects and implementations of the present disclosure relate to methods and systems for facilitating generation of documents. In particular, aspects of the present disclosure relate to methods and systems for facilitating generation of documents in view of key elements of a cloud-based word processing system.

### BACKGROUND

A document may be generated for distribution. For example, a newsletter may be generated to be distributed to a target audience. Various methods may be utilized for rendering a document for distribution. Methods for document rendering may suffer from one or more shortcomings.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for generating a newsletter, according to some embodiments.

FIG. 2 is a block diagram of a data flow for generating a rendered newsletter, according to some embodiments.

FIG. 3A is an example source document for generating a newsletter, as it may appear in a cloud-based word processing application, according to some embodiments.

FIG. 3B is an example newsletter based on a source document, according to some embodiments.

FIG. 4 is a flow diagram of a method for generating a document based on a cloud-based word processing source, according to some embodiments.

FIG. 5 is a block diagram illustrating an exemplary computer system, in accordance with implementations of the present disclosure.

### DETAILED DESCRIPTION

Aspects of the present disclosure relate to methods and systems for generating a document using input from a cloud-based word processing application. Generating the document may include importing information from the cloud-based word processing application, performing some operations on data retrieved from the cloud-based word processing application, receiving key elements from the cloud-based word processing application, separating the data retrieved from the cloud-based word processing application into components based on the keywords, etc. Key elements may include keywords, key formatting, key characters, or the like. Generating the document may include rendering one or more web pages, e.g., for presenting content, presenting the document, presenting a newsletter, etc. Generating the document may include generating one or more HTML files to display information retrieved from the cloud-based word processing application. The document may be a newsletter, e.g., an electronic newsletter. Throughout this disclosure, the word “newsletter” will be used for brevity, but the document may be another type, such as a bulletin, a journal, a magazine, a textbook, etc.

In some conventional systems, generating a digital newsletter may include an author generating a document in an accepted format (e.g., a format associated with a word processing application) and submitting the document to a processing device configured to convert the document to a format appropriate for a digital newsletter. For example, the processing device may be configured to accept text data in an approved format and generate one or more HTML files configured to display a newsletter. This method may be cumbersome. This method may not allow for multiple articles to be generated at once. This method may include submitting a document via a form, such as an online submission form. This method may include submitting separate articles via a separate submission form, submission field, or the like. This method may include providing additional information not found within the document. For example, a submission form may include separate fields for an article title, newsletter title, authors, teaser, or the like. This method may include submitting documents considered to be complete to the processing device (e.g., via a web submission form). This method may not provide feedback to an author on how a finished document may appear. The work-in-progress document (e.g., a document saved on a computer of an author) may not resemble a final product (e.g., a published newsletter). It may be difficult, inconvenient, expensive, or impossible to check an appearance of the newsletter while articles are being written. In some conventional systems, data associated with a document may be submitted to be rendered. A method to view the rendered document may then be provided to the user. The user may submit updated data, e.g., by filling out a submission form, uploading a document, or the like, to view a new rendered version. Continuing to supply new data, new source documents, or the like in order to view updated rendered documents may be expensive, inconvenient, and/or time consuming.

In some conventional systems, an author of a newsletter may generate content in a format that may be rendered into a webpage, rendered into a digital newsletter, compiled into a viewable format, or the like. For example, an author may write a newsletter in extensible markup language (XML). With a method of viewing output, an author working within such a system can easily view a layout of the newsletter, e.g., by compiling the XML file. Such formats may not be user-friendly. An author (e.g., of a newsletter) may be unfamiliar with such file formats. The format may not be written in a way that resembles the finished product. Generating a file in the format may include learning language syntax, special character use, etc. Such shortcomings increase a burden of generating an electronic newsletter, a cost of generating an electronic newsletter, etc. Additionally, a newsletter file may be stored locally, e.g., via the memory of an author's computing device. Collaboration between multiple authors may be inconvenient in such a system.

Aspects of the present disclosure may address one or more of the shortcomings of conventional systems. In some embodiments, a newsletter may be written utilizing a cloud-based word processing system. The cloud-based word processing system may be accessed via the Internet, by a web browser, a dedicated application, a personal computer, a tablet, a smartphone, etc. The text of a cloud-based word processing document associated with a newsletter may be primarily natural, e.g., a majority of the text of the document may be part of an article to be published in the newsletter. Some key elements may be included. Key elements may be utilized to indicate categorization of content, such as differentiating between a title and body of an article. Key elements may be utilized to separate sections, separate articles, define author, title, and teaser fields, designate some content as paid, premium, or subscription content, or other purposes. Key elements may be simple. For example, certain words, combinations of characters, or formatting may be utilized to define a key element. Key elements may separate the content of a cloud-based word processing document into components, such as one or more title components, one or more article teaser components, one or more article body components, etc.

Contents of the cloud-based word processing document, ancillary data, etc., may be provided to a processing device. The processing device may access the cloud-based word processing document via the internet. The processing device may access the cloud-based word processing document via an application programming interface (API). The processing device may determine key elements from the document. The processing device may format, render, arrange, etc., a newsletter based on the key elements. The processing device may generate a newsletter based on the key elements and components of the document. Components may include text (e.g., article bodies, titles, authors, etc.), images, tables, lists, etc. Ancillary data may include additional data associated with the cloud-based word processing document, such as a title of the document, metadata, storage information such as a folder the document is stored in, creation and/or edit date, etc.

The processing device may be part of a newsletter processing system. The newsletter processing system may generate a newsletter based on the data received from the cloud-based word processing application. The newsletter processing system may generate one or more files to facilitate consumption and/or delivery of the newsletter. The newsletter processing system may generate one or more hypertext markup language (HTML) files, e.g., to be rendered using a web browser application. The newsletter processing system may generate a uniform resource locator (URL) to facilitate a user accessing the newsletter, an author or editor viewing the newsletter, or the like.

Methods and systems of the present disclosure provide technical advantages over conventional methods. Utilizing existing cloud-based word processing applications provides a number of benefits. Many cloud-based word processing applications allow many authors to contribute to a document. Multiple authors may be able to contribute to a document simultaneously. Some cloud-based word processing applications are commonly used or closely resemble commonly used word processing systems, decreasing time and cost investments for a user to become proficient in their use. Utilizing cloud-based word processing applications provides access to authors and/or other newsletter contributors to functions of the cloud-based word processing application. For example, intuitive formatting methods for headings, fonts, text styles such as italics and bold text, bulleted lists, tables, etc., can be accessed via some cloud-based word processing applications. Such options may be accessible via a graphical user interface (GUI) of the cloud-based word processing application. Images may be easily inserted, resized, cropped, etc., via a cloud-based word processing application. Cloud-based word processing applications may include drawing tools for authors to generate and/or edit drawings within the application. Cloud-based word processing applications may allow authors, editors, and/or other contributors to insert comments, tag other contributors in comments, utilize comments for improved workflow, cause messages to be sent to other contributors, etc., allowing for more convenient collaboration. Cloud-based word processing applications may include offline editing methods. Cloud-based word processing applications may include import/export options for other file types/formats, such as formats associated with common word processing applications. Cloud-based word processing applications may include integration with other applications, such as spreadsheet applications, presentation applications, or other applications to enable generation of integrated content. Cloud-based word processing applications may include a variety of additional functionality, such as add-ons, and/or the ability for a contributor to generate custom add-ons to perform target functions. Cloud-based word processing applications may include robust auto-save features, recovery of past saves or versions, etc. Cloud-based word processing applications may be accessible from a variety of devices, such as personal computers, laptops, tablets, smartphones, etc.

Utilizing a cloud-based word processing application may enable the use of simple key elements for use by a newsletter processing system for generating a newsletter. A few simple rules may be established for use by the newsletter processing system to identify key elements, separate various newsletter components, etc. For example, a line of text including only the word “authors” may indicate that the next paragraph includes a set of the text belonging to an “author” field, a line of text including only the word “teaser” may indicate the following text is an article teaser, etc. As another example, a line of text formatted in a “heading” or “title” format of the cloud-based word processing application may be recognized by a newsletter processing system as an article title, section title, etc. Specific implementations of rules may differ, but the environment of a cloud-based word processing system may enable a newsletter processing system to recognize rules that are easy for an author or another contributor to learn to utilize, reducing the cost of training contributors for newsletter generation.

Utilizing a cloud-based word processing application to generate a newsletter may enable providing feedback on the rendered newsletter as the newsletter is being written, is in progress, or the like. A newsletter processing system may provide an interface to an author/contributor, e.g., via a web browser, via an app, through the internet, etc. The interface may allow the contributor to view the rendered newsletter at any time while editing the cloud-based word processor document. For example, the interface may have an option to compile a newsletter based on the current version of the cloud-based word processing document. The interface may display the newsletter, provide a URL, etc., to enable the contributor to view the newsletter based on the current version of the cloud-based word processing document.

In some aspects of the present disclosure, a method includes receiving first data from a cloud-based word processing system. The method further includes extracting, from the first data, one or more key elements. The method further includes dividing the first data into components based on the one or more key elements. The method further includes rendering a first document based on the components of the first data and the one or more key elements.

In some aspects of the present disclosure, a system includes memory and a processing device coupled to the memory. The processing device is to receive first data from a cloud-based word processing system. The processing device is further to extract, from the first data, one or more key elements. The processing device is further to divide the first data into components based on the one or more key elements. The processing device is further to render a first document based on the components of the first data and the one or more key elements.

In some aspects of the present disclosure, a non-transitory machine-readable storage medium stores instructions which, when executed, cause a processing device to perform operations. The operations include receiving first data from a cloud-based word processing system. The operations further include extracting, from the first data, one or more key elements. The operations further include dividing the first data into components based on the one or more key elements. The operations further include rendering a first document based on the components of the first data and the one or more key elements.

In some aspects of the disclosure, an author/contributor may generate a document. The document may be generated via a cloud-based word processing system. The document may be generated according to one or more rules, e.g., rules that enable a processing device to extract key elements from the document, rules that enable a processing device to separate components of a document, etc. A newsletter processing system may be provided access to the document. The newsletter processing system may extract newsletter issue components from the document. The newsletter processing system may store the components in a database. The newsletter processing component may render a newsletter in view of the stored components.

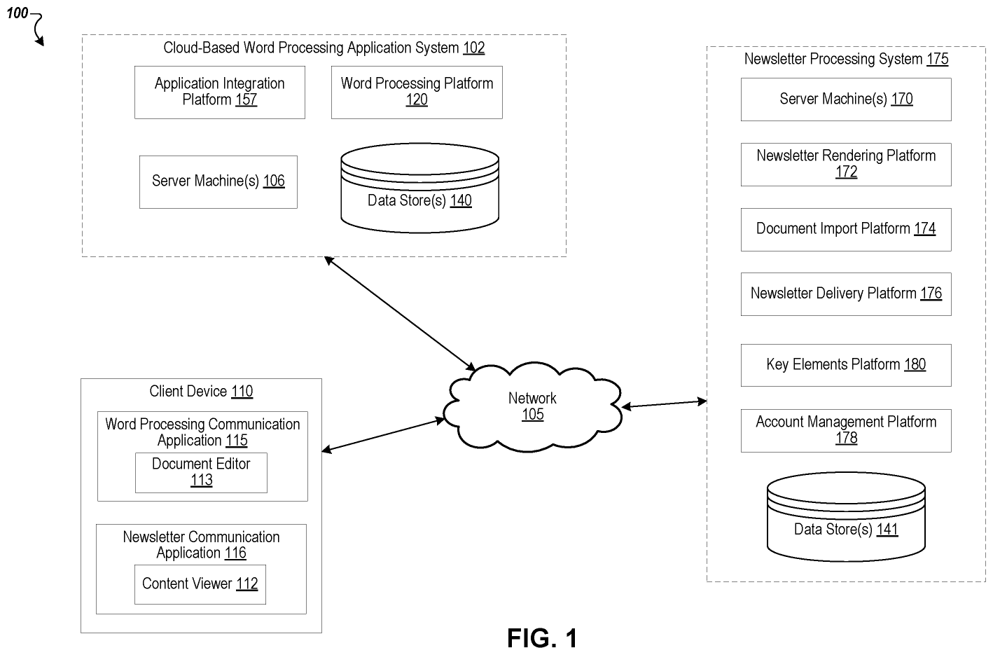

FIG. 1 illustrates an example system architecture 100 for generating a newsletter, according to some embodiments. System architecture 100 includes client device 110, one or more networks 105, cloud-based word processing application system 102, and newsletter processing system 175. Cloud-based word processing application system 102 includes one or more server machine 106, one or more data stores 140, and a variety of platforms for performing tasks associated with cloud-based word processing. Platforms of cloud-based word processing application system 102 may be hosted by one or more server machines 106. Platforms of cloud-based word processing application system 102 may include and/or be hosted on one or more computing devices (such as rackmount server, router computer, server computer, personal computer, mainframe computer, laptop computer, tablet computer, desktop computer, etc.) and one or more data stores (e.g., hard disks, memories, databases, etc.) and may be coupled to one or more networks 105.

In some embodiments, components of cloud-based word processing application system 102 (e.g., server machines 106, data stores 140, hardware associated with one or more platforms, etc.) may be directly connected to one or more networks 105. In some embodiments, one or more components of cloud-based word processing application system 102 may access networks 105 via another device, e.g., a hub, switch, etc. In some embodiments, one or more components of cloud-based word processing application system 102 may communicate directly with other components depicted in FIG. 1, e.g., components of newsletter processing system 175 such as server machine(s) 170, client device 110, etc. Data stores 140 may be included in one or more server machines 106. Data stores 140 may include external data storage. Data store 140 may be of another type of data storage. Platforms of cloud-based word processing application system 102 may include application integration platform 157 and word processing platform 120. Further platforms may be included, such as document format conversion platforms, document upload and/or download platforms, etc.

Newsletter processing system 175 may include server machine 170 and one or more data stores 141. Server machine(s) 170 and data stores(s) 141 may share features with analogous components of cloud-based word processing application system 102, e.g., may be enacted by various computing and/or memory devices, operations of these devices may be performed by more or fewer devices than pictured, etc. Newsletter processing system 175 may include further devices, e.g., data stores, further servers, etc. Multiple operations of newsletter processing system 175 may be performed by a single physical or virtual device.

The one or more networks 105 may include one or more public networks (e.g., the Internet), one or more private networks (e.g., a local area network (LAN), a wide area network (WAN), one or more wired networks (e.g., Ethernet network), one or more wireless networks (e.g., an 802.11 network), one or more cellular networks (e.g., a Long Term Evolution (LTE) network), routers, hubs, switches, server computers, and/or a combination thereof. In one implementation, some components of architecture 100 are not directly connected to each other. In one implementation, system architecture 100 includes multiple separate networks 105.

The one or more data stores 140 and 141 may reside in memory (e.g., random access memory), cache, drives (e.g., hard drive), flash drives, etc., and may be part of one or more database systems, one or more file systems, or another type of component or device capable of storing data. The one or more data stores 140 and 141 may include multiple storage components (e.g., multiple drives or multiple databases) that may also span multiple computing devices (e.g., multiple server computers). The data store may be persistent storage that is capable of storing data. A persistent storage may be a local storage unit or a remote storage unit, electronic storage units (e.g., main memory), or a similar storage unit. Persistent storage may be a monolithic device or a distributed set of devices.

Cloud-based word processing application system 102 may include platforms, e.g., for performing functions associated with word processing. Cloud-based word processing application system 102 may include word processing platform 120. Word processing platform 120 may enable word processing. For example, word processing platform 120 may store and retrieve documents, interface with a client device, provide access to a user's documents, etc. Cloud-based word processing application system 102 may include application integration platform 157. Application integration platform 157 may facilitate links between word processing platform 120 and other platforms, such as spreadsheet platforms, presentation platforms, drawing tools, etc.

Client devices 110 may include devices, such as smart televisions, smartphones, personal digital assistants, portable media players, laptop computers, electronic book readers, tablet computers, desktop computers, gaming consoles, set-top boxes, etc. Operations associated with client device 110 may be performed by one or more devices, e.g., two devices associated with a user, multiple devices associated with multiple users, etc.

A client device 110 may include one or more applications. Client device 110 may include word processing communication application 115 for communicating with one or more components of cloud-based word processing application system 102. Client device 110 may include newsletter communication application 116 for communicating with one or more components of newsletter processing system 175. Operations of word processing communication application 115 and newsletter communication application 116 may be performed by a single application or multiple applications. Word processing communication application 115 and newsletter communication application 116 may be purpose-built applications, web browsers, etc. Word processing communication application 115 may include document editor 113. Document editor 113 may enable a user to access documents, e.g., documents of cloud-based word processing application system 102. Document editor 113 may enable browsing, viewing, editing, etc., documents of cloud-based word processing application system 102. Access to documents may be tied to a particular user (e.g., via a sign-in system), a particular client device 110, etc. Documents accessed via document editor 113 may include newsletter documents, e.g., word processing documents to be formatted as newsletters. As used herein, a “document” associated with a word processing application may be an electronic file, storing information that can be loaded by the word processing application, to allow word processing operations. In some embodiments, word processing communication application 115 may be an application that allows users to compose, send, and receive documents (e.g., to be converted to a newsletter) over a platform (e.g., word processing platform 120) and/or a combination of platforms and/or networks. The word processing communication application 115 associated with client device 110 may render, display, present, and/or play one or more documents to one or more users. For example, word processing communication applications 115 may provide user interfaces (e.g., a graphical user interface) to be displayed on client device 110 for receiving, viewing, and/or editing documents. In some embodiments, word processing communication application 115 is associated with (and managed by) cloud-based word processing application system 102.

Client device 110 may include newsletter communication application 116. Newsletter communication application 116 may enable communication between client device 110 and one or more components of newsletter processing system 175. Operations of newsletter communication application 116 may include providing data to newsletter processing system 175, requesting and/or receiving data from newsletter processing system 175, etc. Newsletter communication application 116 may be or include a web browser, a web browsing application, etc. Newsletter communication application 116 may provide access to one or more documents to newsletter processing system 175 (e.g., newsletter communication application 116 may provide a URL to newsletter processing system 175 for accessing one or more documents associated with word processing platform 120). Newsletter communication application 116 may include content viewer 112. Content viewer 112 may perform operations to enable a user to view a rendered newsletter. Content viewer 112 may receive data from newsletter rendering platform 172. Content viewer 112 may access a URL generated by newsletter processing system 175. Newsletter communication application 116 may render, display, and/or present one or more newsletters. For example, newsletter communication application 116 may provide one or more user interfaces to be displayed on client device 110 for receiving/viewing rendered newsletter documents. Newsletter communication application 116 may provide one or more user interface elements for prompting a user to provide data to newsletter processing system 175, fields to enter data to be provided to newsletter processing system 175, or the like. In some embodiments, newsletter communication application 116 is associated with (e.g., managed by) newsletter processing system 175.

In some embodiments, cloud-based word processing application system 102 includes word processing platform 120 (e.g., hosted by server machine(s) 106). Word processing platform 120 may store, retrieve, provide, receive, etc., data related to one or more documents. Word processing platform 120 may provide document data to word processing communication application 115, to document import platform 174, etc. In some embodiments, cloud-based word processing application system 102 may include one or more platforms for importing and/or exporting documents, e.g., format conversion platforms, upload and/or download platforms, etc. Application integration platform 157 may enable integration between word processing platform 120 and a variety of tools, e.g., for inclusion of spreadsheet information in a document, slideshow data in a document, drawing tools, etc.

In some embodiments, communication applications 115 and 116 installed on client device 110 may be associated with a user account, e.g., a user may be signed in to an account on the client device 110. In some embodiments, multiple client devices 110 may be associated with the same client account. In some embodiments, providing information regarding product association(s) with one or more items, documents, newsletters, etc., may be performed subject to the user account, e.g., account settings, account history, etc.

In some embodiments, client devices 110 may include one or more data stores. Data stores may include commands (e.g., instructions, which cause operations when executed by a processing device) to render a user interface (UI) (e.g., associated with a communication application). The instructions may include instructions to render an interactive component, e.g., a UI element a user may interact with to be presented with more/different information, to perform an action, to edit a document, etc.

In some embodiments, the one or more server machines 106 and 170 may include computing devices such as rackmount servers, router computers, server computers, personal computers, mainframe computers, laptop computers, tablet computers, desktop computers, etc., and may be coupled to one or more networks 105. Server machines 106 may be independent devices or part of any of the platforms.

Newsletter processing system 175, and server machine(s) 170 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of newsletter processing system 175, server machines(s) 170, data store(s) 141, etc., may be performed by a cloud computing service, cloud data storage service, etc. Data store(s) 141 may store data associated with newsletter processing operations, such as newsletter components, rules for converting a word processing document to a newsletter, information associated with delivery systems, user accounts, user account tiers and preferences, etc.

Newsletter processing system 175 may include one or more platforms, e.g., for performing tasks associated with newsletter processing operations. Newsletter processing system 175 may include document import platform 174. Document import platform 174 may enable newsletter processing system 175 to receive documents, e.g., via network 105, from cloud-based word processing application system 102, etc. Document import platform 174 may retrieve data to be rendered as a newsletter by newsletter processing system 175.

Newsletter processing system 175 may include key elements platform 176. Key elements platform 176 may be configured to extract key elements from document data, e.g., document data imported from cloud-based word processing application system 102. Key elements platform 176 may be configured to separate document data into components, e.g., based on the key elements. Key elements platform 176 may store components of one or more documents in data store(s) 141 for further use.

Key elements may include formatting, syntax, additional data, etc., associated with a document to be used in generating a newsletter. For example, a folder that stores a document in memory of cloud-based word processing application system 102 may be a key element, e.g., the name of a newsletter. The title of a document may be a title of an issue of the newsletter. Words, symbols, formatting, etc., in the body of a document may indicate that an element of the document is a key element, may define and/or separate components of the document, etc. Any combination of characters, words, formatting, etc., may be recognized as a key element, subject to a set of rules recognized by newsletter processing system 175. Formatting may indicate a key element, for example, a “heading” or “title” format option may indicate a title of an article or newsletter. A combination of characters and formatting may indicate a key element, for example, a line containing only the word “authors” or a paragraph starting with the word “authors” in all capital letters may indicate that the following section includes article author names. A paragraph including only the word “premium” or specifying a subscription level may mark the content of the article as being for a particular group of subscribers, such as paid subscribers, paid subscribers of a specified level or tier, or the like. Characters may indicate a key element, for example utilizing special characters (e.g., characters unlikely to be used in the text of a newsletter) may indicate a key element, separate document components, etc. Key elements platform 180 may store components separated by key elements in data store(s) 141. Key elements platform 180 may store data labeling/classifying components, e.g., as a title, article teaser, article body, etc.

In some embodiments, key elements may include flexible syntax. For example, key elements platform 180 may accept several alternate syntaxes, spellings, formats, etc., as key elements, separators as components, defining components, or the like. Key elements platform 180 may accept a range of indicators of a key element, e.g., any combinations that conform to one or more rules. In some embodiments, key elements platform 180 may determine key elements of a document based on output of a model, such as a machine learning model, a rule-based model, or the like.

Newsletter processing system 175 may include newsletter rendering platform 172. Newsletter rendering platform may retrieve document components from data store(s) 141 and generate a newsletter. Generating a newsletter may include generating one or more electronic files based on the document components. Generating a newsletter may include generating one or more HTML files, e.g., to be displayed by an internet browser. Other formats/file types may also be used, e.g., a PDF file may be generated by newsletter rendering platform 172. Newsletter rendering platform 172 may generate one or more files based on document components and/or document component labels retrieved from data store(s) 141.

Newsletter processing system 175 may include newsletter delivery platform 176. Newsletter delivery platform 176 may perform operations associated with providing a newsletter to a user. Newsletter delivery platform 176 may publish the newsletter to a website, generate a URL to access the newsletter, coordinate notifying subscribers of a new issue of a newsletter, etc. Newsletter delivery platform 176 may communicate with one or more users, e.g., via email, via an in-app message, etc., to indicate a new newsletter, a new issue of a newsletter, etc. Newsletter delivery platform 176 may deliver different messages to different users, e.g., based on user preferences, based on a user subscription/account tier (e.g., based on how much interest a user has in a topic associated with the newsletter, based on a fee paid by the user, etc.), or the like. Newsletter delivery platform 176 may provide a URL to access the newsletter.

Newsletter processing system 175 may include account management platform 178. Account management platform 178 may manage user accounts associated with newsletter processing system 175. Account management platform 178 may manage username/password use, user account settings/preferences, access to components of newsletter processing system 175, etc. Account management platform 178 may be utilized in newsletter generation, e.g., a user may sign into a user account of newsletter processing system 175 for newsletter generation. Account management platform 178 may be utilized in newsletter delivery, e.g., user accounts, user emails, user delivery preferences, and/or user subscription tiers and/or settings may be referenced by newsletter delivery platform 176.

In some embodiments, the functions of client device 110, newsletter processing system 175, cloud-based word processing application system 102, server machines 106 and 170, etc., may be provided by a fewer number of machines. For example, server machines 170 and 106 may be integrated into a single machine in some embodiments. In some embodiments, client device 110 and server machine 106 may be integrated into a single machine. In some embodiments, functions of client device 110, server machine 106, server machine 170, and data store 140 may be performed by a cloud-based service.

In general, functions described in one embodiment as being performed by client device 110, server machine 106, and server machine 170 may also be performed on server machine 106 in other embodiments, if appropriate. In addition, the functionality attributed to a particular component can be performed by different or multiple components operating together. For example, in some embodiments, multiple client devices may be utilized to access newsletter processing system 175. In another example, a first client device may communicate with cloud-based word processing application system 102, and a second client device may communicate with newsletter processing system 175. In another example, operations of word processing communication application 115 and newsletter communication application 116 may be performed by a single application.

In addition, the functions of a particular component can be performed by different or multiple components operating together. One or more of the server machine 106, server machine 170, data stores 140 and 141, etc., may be accessed as a service provided to other systems or devices through appropriate application programming interfaces (API).

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline, such as a topic channel, of one or more platforms, one or more content items, etc. Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

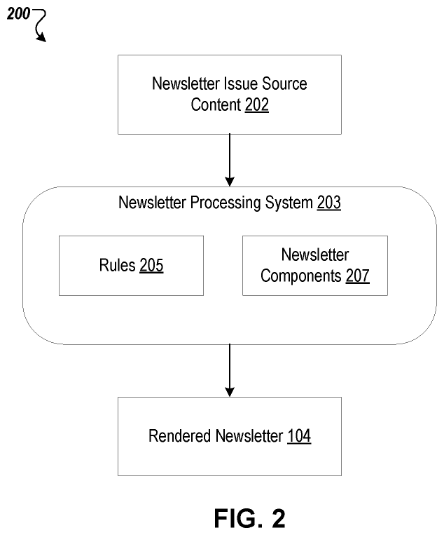

FIG. 2 is a block diagram of a data flow 200 for generating a rendered newsletter, according to some embodiments. Newsletter processing system 203 (e.g., newsletter processing system 175 of FIG. 1) may receive source content and generate a newsletter based on the source content.

Newsletter processing system 203 may receive newsletter issue source content 202. Newsletter issue source content may include a document, such as a document generated by a word processing application. Newsletter issue source content 202 may include a cloud-based word processing application document. Newsletter issue source content 202 may be provided to newsletter processing system 203 via the internet, via an API of a cloud-based word processing application, etc. Newsletter issue source content 202 may include text of one or more documents, images, formatting, titles, ancillary data associated with the one or more documents, etc.

Newsletter processing system 203 may separate a document into newsletter components 207, according to rules 205. Rules 205 may include a list of conditions defining key elements of a document. Rules 205 may include a list of conditions prescribing separation of the document into newsletter components. Rules 205 may be enacted by a model, e.g., a model configured to determine a likelihood that characters, formatting, or the like of the document indicate an intended key element.

Rules 205 may be designed to maintain simplicity of the source document, readability of the document, similarity of the document to the rendered newsletter, or the like. Rules 205 may define key elements of the document, enable generation of components of the newsletter, etc. Separation of components of the newsletter may enable a variety of newsletter formats, styles, arrangements, etc. Final newsletter layout may be customized independently of the customization of rules, key element indicators, etc.

Rules 205 may include references to combinations of characters, formatting of characters, ancillary data such as document title, etc. Rules 205 may be used to define newsletter components. Rules 205 may be used to separate the document into newsletter components. Rules 205 may be flexible, e.g., may be adjusted for a target environment or application. Rules 205 may include methods for generating newsletter components such as newsletter title, newsletter issue title, article title, article authors, article teaser, article content, premium content, etc.

Rules 205 may include instructions for newsletter processing system 203 to perform actions based on any selected formatting, character combinations, combinations of target formatting and characters, etc., of the source document. Some example rules that may be included in rules 205 are outlined here, these examples are to be understood to be illustrative, rather than restrictive. The title of a source document may be a title of a newsletter, newsletter issue, newsletter article, etc. A string of characters in a particular format may be a title of a newsletter issue, newsletter article, etc. For example, the cloud-based word processing application may have a “title” format or “heading” format, characters in such formats may be understood by newsletter processing system 203 to be titles, headings, etc. Content between titles (e.g., characters presented in a “title” format) may include article bodies. Article bodies may include text, images, tables, or other types of content. Content between titles may include key elements identifying other newsletter components. Some formatting of text may be maintained, e.g., newsletter components 207 may include some formatting of text and other elements. Font style, font size, paragraph style, etc., may be maintained by newsletter processing system 203 between the source document and the rendered newsletter. One or more rules 205 may be directed toward generating a component indicating one or more authors of an article. For example, a line including only the word “authors” may indicate that the next line includes an author component, a paragraph beginning with a particular string of characters and/or formatting may indicate that the remainder of the paragraph includes names of authors, etc. Similar one or more rules 205 may indicate article teasers, art credits, or other components of the newsletter. One or more rules 205 may be directed toward restricting content for one or more users. For example, a newsletter may include some content available to be viewed by all users, and some content restricted to premium users. A newsletter may include different, potentially overlapping, sets of content available to different categories of users, e.g., based on user preferences, user payment tier, etc. One or more rules may be used to indicate that content of a newsletter is reserved for one or more groups of users. A line including only the line “premium,” for example, may indicate that the following paragraph, the remainder of the article, the remainder of the newsletter, the entire newsletter, etc., is available to users of a premium tier. Levels or categories of access may be indicated, e.g., by use of key elements such as “premium1, premium2,” etc.

Rules 205 may include recognizing text formatted in a target style of the newsletter issue source content 202 as a key element. Rules 205 may include recognizing text formatted in a target style of the newsletter issue source content 202 and a newsletter component. Rules 205 may include recognizing text formatted in a target style of a source document as an article title. Rules 205 may include recognizing text between, before, and/or after text formatted in a target style in a source document as belonging to an article associated with the text formatted in the target style. Rules 205 may include recognizing text after text formatted in a target style as belonging to an article defined by the text formatted in the target style. Rules 205 may include recognizing text between two portions of text formatted in a target style as being associated with the text formatted in the target style before and/or after the text that is not formatted in the target style. The target style may include text style, such as bold, italic, underlined, etc. The target style may include font size. The target style may include font style. The target style may be a pre-set style of a cloud-based word processing system.

Rules 205 may include extracting the name of a source document as a title. Rules 205 may include extracting the name of a source document as an article title. Rules 205 may include extracting the name of a source document as an issue title. Rules 205 may include extracting the name of a source document as a newsletter title.

Rules 205 may include recognizing labels in a source document as key elements. Rules 205 may include recognizing labels as defining newsletter components. Rules 205 may include recognizing labels as separating newsletter components. Labels may include labels defining author fields, teaser fields, premium content fields, etc. Labels may be defined by text, formatting, a combination of text and formatting, etc. For example, the word “authors” alone in a paragraph may indicate that the following component (e.g., until the next label in the source document, until the next key element in the source document, etc.) is to be processed as an “author” newsletter component.

In some embodiments, a single issue's content may correspond to a single source document. For example, several “title” key elements may separate article bodies for several articles associated with the issue. In some embodiments, multiple documents may contribute to one issue. Each document may correspond to an article, a group of articles, a section of articles, articles of the same author, etc. In some embodiments, a storage system associated with a cloud-based word processing system may be utilized to extract key elements, newspaper components, etc. For example, a folder of a cloud-based word processing system may correspond to an issue of a newsletter, with articles associated with documents within the folder. The name of the folder may be extracted as a key element. The name of the folder may be associated with the name of an issue. In another example, a folder of a cloud-based word processing system may correspond to a newsletter. Documents within the folder may correspond to issues of the newsletter, folders with in the folder may correspond to issues of the newsletter, etc. The name of the folder storing the newsletter may be extracted as a key element corresponding to the title of the newsletter.

In some embodiments, a lack of one or more expected key elements may result in an error message being generated during newsletter generation. In some embodiments, a lack of expected key element may result in a blank element or default element being included in the generated newsletter. Conflicting key elements (such as multiple author elements in the same article, multiple premium elements in the same article, etc.) may similarly default to some selected behavior, cause generation of an alert for a user, or the like.

Key element syntax may be selected for readability, ease of use, ease of learning, or another metric. Key element syntax may be simple for an author to learn, use, and manage, e.g., an author without coding or programming experience. Some syntax may be utilized in some embodiments to utilize formatting and/or characters that would normally be a key element, e.g., an escape character or set of characters.

In some embodiments, newsletter components 207 may include methods to access a source document. For example, a URL for accessing a source document may be included in newsletter components 207. An author or contributor may have access to a user interface associated with newsletter processing system 203. The author may provide an input to a user interface of newsletter processing system 203 to cause newsletter processing system 203 to generate a newsletter from newsletter issue source content 202. The author may update the source document (e.g., via a user interface associated with a cloud-based word processing application) and cause the newsletter processing system 203 to generate the newsletter again, e.g., to observe what effect the update to the source document has on the rendered newsletter 104.

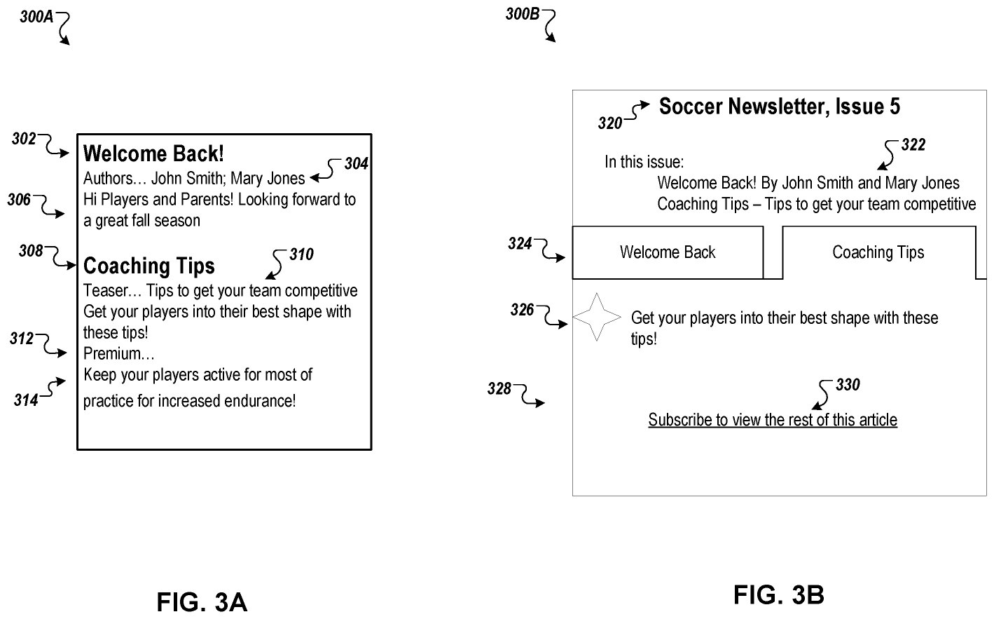

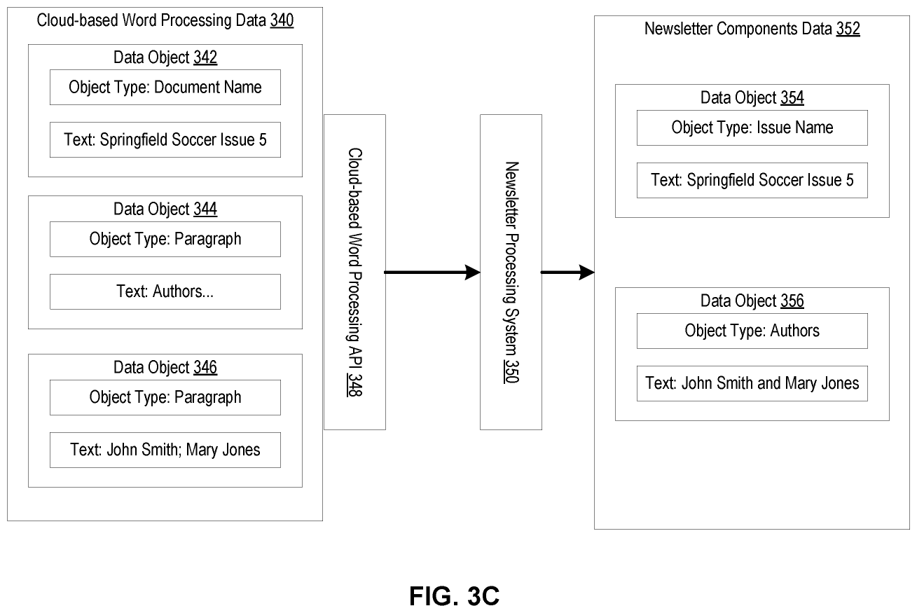

FIG. 3A is an example source document 300A for generating a newsletter, as it may appear in a cloud-based word processing application, according to some embodiments. Source document 300A may include key elements, e.g., to be separated/stored as newsletter components by a newsletter processing system. Example source document 300A may include a title, e.g., a title of the document saved by the cloud-based word processing application. Example source document 300A may, for instance, have a title such as “Soccer Newsletter, Issue 5.” Source document 300A may be written in a style conforming to rules to enable a newsletter processing system to generate a newsletter from the source document. Source document 300A may include multiple articles. Source document 300A may include title 302. Title 302 may be written in a particular format, e.g., a combination of text size and style, a default “title” or “heading” style of the cloud-based word processing application, etc. A newsletter processing system may interpret characters in the target style as indicating a new article, an article title, etc. The article title may be a key element, a newsletter component, etc. The first article of example source document 300A further includes an author field 304, with key elements including starting a line with “authors . . . ” and the rest of the line being interpreted by a newsletter processing system as including an author component for the article where the key element is located. The first article of example source document 300A further includes body 306, including text of the article, which may further include formatting such as text style, paragraph breaks, etc., images, tables, lists, or other content to be included in the newsletter.

Example source document 300A includes a second article. The second article begins with title 308. Title 308 may share one or more features with title 302. A newsletter processing system may associate content between titles with the previous title. The second article of example source document 300A includes a teaser 310. The teaser 310 may be indicated by a key element. The example key element includes beginning a new line with “teaser . . . ” followed by the text of the teaser. The second article of source document 300A includes a premium tag 312. The premium tag 312 may indicate that some or all content of the newsletter is marked as premium. The premium tag 312 may indicate that some or all content of the newsletter article is marked as premium. The premium tag 312 may indicate that portions of the article and/or newsletter after the premium tag are marked as premium, are only available to premium users, etc. The second article of example source document 300A includes article body 314.

FIG. 3B is an example newsletter 300B based on a source document, according to some embodiments. Example newsletter 300B is associated with example source document 300A. Many other specific arrangements of components in a rendered newsletter are possible and within the scope of this disclosure. Example newsletter 300B is meant to be illustrative, rather than restrictive.

Example newsletter 300B may be viewed by a user interface of an application associated with a client device. Example newsletter 300B may be viewed via an application associated with a newsletter processing system. Example newsletter 300B may be viewed by another application, e.g., a web browser.

Example newsletter 300B includes title 320. A newsletter may optionally include such a title. Title 320 may be entered by a contributor to the newsletter processing system. Title 320 may be included in source content, e.g., the title of a source document. Example newsletter 300B includes a list of contents 322. A newsletter enabled by aspects of this disclosure may include such a list. List of contents 322 may be presented as a table, e.g., with references to a page number. List of contents 322 may be interactive, e.g., interacting with a title of an article may link to article contents. List of contents 322 may include titles, authors, teasers, and/or other information. The newsletter processing system may include rules for what information is presented in a list of contents. For example, the newsletter processing system may include authors if the article includes an author component, and a teaser if the article does not include an author component.

Example newsletter 300B includes content tabs 324. In some embodiments, articles may be presented via tabs, categories, partitions, or other presentation methods. Articles may be listed in an order (e.g., the order they appear in the source document). Articles may all be included in a single view. Arrangement and inclusion of elements in a rendered newsletter may be customizable, e.g., via the newsletter processing system.

Example newsletter 300B includes premium tag 326 for indicating that an article includes premium content. A premium tag may optionally be included in a rendered newsletter. Premium tags may be displayed in various locations to indicate that an article, issue, newsletter, etc., includes premium content. For example, a premium tag may be displayed in the list of content 322, content tabs 324, etc.

Example newsletter 300B includes content 328. Content may include content imported from a source document (e.g., example source document 300A). Example newsletter 300B further includes a premium content message 330. Premium content message 330 may facilitate updating user preferences, subscription tier, or the like, for access to the premium content. For example, premium content message 330 may provide a link to a webpage for subscribing to the newsletter.

FIG. 3C is a block diagram depicting storage of newsletter components in view of newsletter processing system rules, according to some embodiments. Newsletter components may be generated based on cloud-based word processing data 340. A cloud-based word processing document data may include a number of data objects, data functions, data classes, data structures, or the like. Cloud-based word processing data 340 includes data objects 342, 344, and 346. Data object 342 corresponds to the name of the cloud-based word processing document, e.g., the file name. Data objects 344 and 346 are paragraph objects, and contain text data. Newsletter processing system 350 receives data objects from cloud-based word processing data 340. Newsletter processing system 350 may receive data from cloud-based word processing data 340 via an API of the cloud-based word processing system, cloud-based word processing API 348.

Newsletter processing system 350 is configured via a set of rules. Rules of newsletter processing system 350 may cause newsletter processing system 350 to process data received via cloud-based word processing API 348. Rules of newsletter processing system 350 may cause newsletter processing system 350 to recognize key elements of cloud-based word processing data 340. Rules of newsletter processing system 350 may cause newsletter processing system 350 to separate cloud-based word processing data 340 into components, into components and key elements, etc.

Newsletter processing system 350 may be configured to recognize a data object having the object type of document name as corresponding to the name of a newsletter issue. Newsletter processing system 350 may cause data associated with that data object (e.g., the text of the object) to be stored in a database as a newsletter component data object. Some elements of cloud-based word processing data 340 may be stored to newsletter components. Some elements of cloud-based word processing data 340 may be used to label components, e.g., some key elements may be stored as component labels.

Newsletter processing system 350 may store data objects 354 and 356 as newsletter components data 352. Data objects 354 and 356 may be based on data objects of cloud-based word processing data 340. A data object of newsletter components data 352 may correspond to a data object of cloud-based word processing data 340. Multiple data objects of newsletter components data 352 may correspond to a data object of cloud-based word processing data 340. A data object of newsletter components data 352 may correspond to multiple data objects of cloud-based word processing data 340. Data object 354 is categorized as an issue title. Newsletter processing system 350 may recognize an object of cloud-based word processing data 340 having object type of “document name” as corresponding to a newsletter title, an issue title, an article title, a section title, or the like. Data object 356 is categorized as author data. A data object may be associated with an article, newsletter, issue, or the like. Data object 356 includes text “John Smith and Mary Jones.” Data included in a data object of newsletter component data 352 may be altered from data included in a data object of cloud-based word processing data 340. For example, delineation of author lists may be altered for rendering to a target style. In some embodiments, the rendering system may make such determinations (e.g., while rendering, instead of and/or in addition to changes to data made before storing data objects as newsletter components data 352). Data object 356 is related to both data object 344 and data object 346 of cloud-based word processing data 340. The object type of data object 356 is associated with data object 344. The text of data object 356 is associated with data object 346. Other combinations of relationships between data objects of a document and data objects of a newsletter are possible, and within the scope of this disclosure.

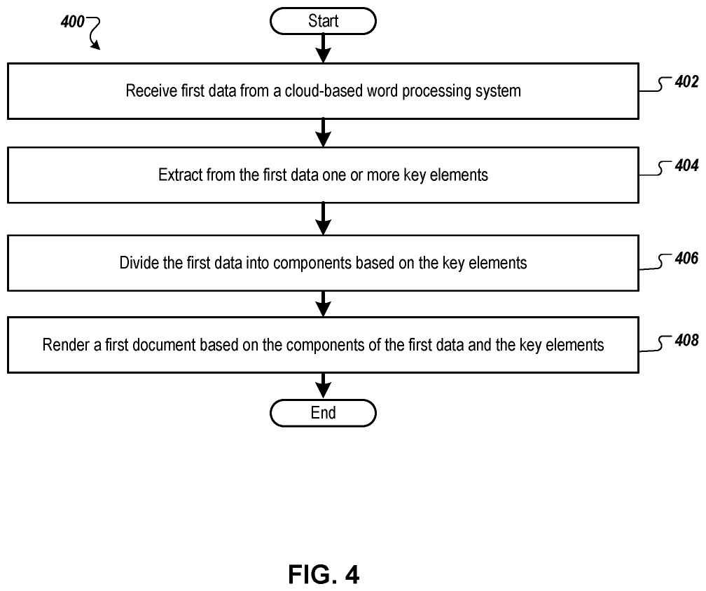

FIG. 4 is a flow diagram of a method 400 for generating a document based on a cloud-based word processing source, according to some embodiments. At block 402, a processing device receives first data from a cloud-based word processing system. The first data may include a source document. The first data may include additional data, e.g., associated with a source document. The first data may be provided to the processing logic via the internet. The first data may be provided to the processing logic via an API of the cloud-based word processing system.

At block 404, processing logic extracts, from the first data, one or more key elements. The key elements may be extracted according to rules of the newsletter processing system. The key elements may include formatting of text, strings of characters, combinations of characters and formatting, etc. Key elements may include text formatted in a target style in the cloud-based word processing system. Key elements may include keywords in the first data.

At block 406, processing logic divides the first data into components based on the key elements. A key element may include a component, e.g., a title of an article may be formatted in a particular style. The title may be a key element, and text of the title may be a component. In some embodiments, a key element is not a component, e.g., a key element may label a component, such as a tag indicating a list of authors. A key element may indicate a title, e.g., a title of an article. A key element may indicate one or more authors. A key element may indicate premium content. A key element may indicate a teaser, e.g., an article teaser. A key element may be part of a document, e.g., a document included in the first data. A key element may be ancillary/additional data associated with a document. For example, first data may include one or more source documents, titles of the one or more documents, and additional metadata. The titles may be key elements. The titles may be, include, or comprise newsletter components.

At block 408, processing logic renders a first document based on the components of the first data and the key elements. The first document may be or include a newsletter. The first document may be an issue of a newsletter. The first document may include articles. The first document may be an electronic document. Rendering the first document may include generating one or more data files. Rendering the first document may include generating one or more HTML files associated with components of the first data in view of the key elements. Processing logic may further generate a URL to enable a user to access the first document, view the first document, etc. Processing logic may further facilitate the delivery of the first document to one or more users. Delivery of the first document to one or more users may include providing the URL to the one or more users. Delivery of the first document to one or more users may include generating a message for the users. Delivery of the first document to one or more users may include sending a message to one or more users via email. Delivery of the first document to one or more users may include sending a message to one or more users via an application, e.g., an application associated with the newsletter processing system.

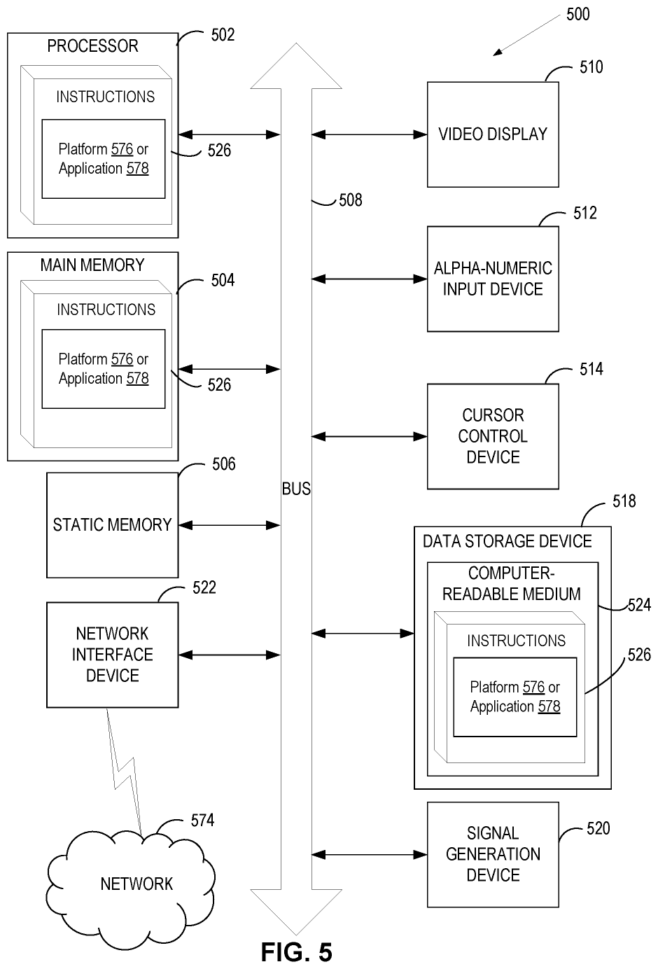

FIG. 5 is a block diagram illustrating a computer system 500, according to some embodiments. In some embodiments, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a Set-Top Box (STB), a Personal Digital Assistant (PDA), a cellular/mobile telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processing device 502, a volatile memory 504 (e.g., Random Access Memory (RAM)), a non-volatile memory 506 (e.g., Read-Only Memory (ROM) or Electrically-Erasable Programmable ROM (EEPROM)), and a data storage device 518, which may communicate with each other via a bus 508.

Processing device 502 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 500 may further include a network interface device 522 (e.g., coupled to network 574). Computer system 500 also may include a video display unit 510 (e.g., an LCD), an alphanumeric input device 512 (e.g., a keyboard), a cursor control device 514 (e.g., a mouse), and a signal generation device 520.

In some embodiments, data storage device 518 may include a non-transitory computer-readable storage medium 524 (e.g., non-transitory machine-readable medium) on which may store instructions 526 encoding any one or more of the methods or functions described herein, including instructions encoding components of FIG. 1. Instructions 526 may encode methods related to a platform 576 (e.g., word processing platform 120 of FIG. 1, newsletter rendering platform 172 of FIG. 1, etc.). Instructions 526 may encode methods related to an application 578 (e.g., word processing communication application 115, newsletter communication application 116, etc.). Instructions 526 may encode platforms, applications, etc., for implementing methods described herein.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium capable of storing or encoding a set of instructions for execution by a computer that causes the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated with the functionality of other hardware components such as ASICS, FPGAs, DSPs, or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” “dividing,” “rendering,” “extracting,” or the like, refer to actions and processes performed or implemented by computer systems that manipulate and transform data represented as physical (electronic) quantities within the computer system registers and memories into other data similarly represented as physical quantities within the computer system memories or registers or other such information storage, transmission or display devices. Also, the terms “first,” “second,” “third,” “fourth,” etc., as used herein, are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general-purpose computer system selectively programmed by a computer program stored in the computer system. Such a computer program may be stored in a computer-readable tangible storage medium.

The methods and illustrative examples described herein are not inherently related to any particular computer or other apparatus. Various general-purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, an electronic data file or portion thereof, and/or a computer. By way of illustration, both an application running on a controller and the controller can be a component. One or more components may reside within a process and/or thread of execution, and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A method, comprising:
receiving first data from a cloud-based word processing system;
extracting, from the first data, one or more key elements;
dividing the first data into components based on the one or more key elements; and
rendering a first document based on the components of the first data and the one or more key elements.

2. The method of claim 1, wherein the key elements comprise indications of one or more of:
article title;
article authors;
premium content; or
article teaser.

3. The method of claim 1, wherein the first document comprises a newsletter.

4. The method of claim 3, wherein the first document comprises an issue of the newsletter, comprising one or more articles, and wherein the first data comprises a title of a document of the cloud-based word processing system, and wherein a first component of the components of the first data of the first document comprises a title of the first document based on the title of the document of the cloud-based word processing system.

5. The method of claim 1, wherein a first key element comprises a keyword formatted in a target style of the cloud-based word processing system.

6. The method of claim 1, wherein rendering the document comprises generating a hypertext markup language (HTML) file to present content associated with components of the first data in view of the one or more key elements.

7. The method of claim 6, further comprising generating a uniform resource locator (URL) to provide access for a user to the rendered document.

8. The method of claim 1, wherein the first data is retrieved via the Internet.

9. The method of claim 1, wherein the first data is retrieved via an application programming interface (API) of the cloud-based word processing system.

10. A system, comprising memory and a processing device coupled to the memory, wherein the processing device is to:
receive first data from a cloud-based word processing system;
extract, from the first data, one or more key elements;
divide the first data into components based on the one or more key elements; and
render a first document based on the components of the first data and the one or more key elements.

11. The system of claim 10, wherein the key elements comprise indications of one or more of:
article title;
article authors;
premium content; or
article teaser.

12. The system of claim 10, wherein the first document comprises a newsletter.

13. The system of claim 12, wherein the newsletter comprises a plurality of articles, and wherein the first data comprises a title of a document of the cloud-based word processing system, and wherein a first component of the components of the first data of the first document comprises a title of the first document based on the title of the document of the cloud-based word processing system.

14. The system of claim 10, wherein a first key element comprises a keyword formatted in a target style of the cloud-based word processing system.

15. The system of claim 10, wherein rendering the document comprises generating a hypertext markup language (HTML) file to present content associated with components of the first data in view of the one or more key elements.

16. A non-transitory machine-readable storage medium storing instructions which, when executed, cause a processing device to perform operations comprising:
receiving first data from a cloud-based word processing system;
extracting, from the first data, one or more key elements;
dividing the first data into components based on the one or more key elements; and
rendering a first document based on the components of the first data and the one or more key elements.

17. The non-transitory machine-readable storage medium of claim 16, wherein the key elements comprise indications of one or more of:
article title;
article authors;
premium content; or
article teaser.

18. The non-transitory machine-readable storage medium of claim 16, wherein the first document comprises a newsletter.

19. The non-transitory machine-readable storage medium of claim 18, wherein the first document comprises an issue of the newsletter, comprising one or more articles, and wherein the first data comprises a title of a document of the cloud-based word processing system, and wherein a first component of the components of the first data of the first document comprises a title of the first document based on the title of the document of the cloud-based word processing system.

20. The non-transitory machine-readable storage medium of claim 16, wherein a first key element comprises a keyword formatted in a target style of the cloud-based word processing system.
